(19) United States
(12) Patent Application Publication
(10) Pub. No.: US 2017/0002100 A1
(43) Pub. Date: Jan. 5, 2017

(54) DEPOLYMERISATION OF POLYSACCHARIDES AND RELATED PRODUCTS

(71) Applicant: LAMBERTI SPA, Albizzate (VA) (IT)

(72) Inventors: Roberto MACCHI, Solbiate Olona (VA) (IT); Angelo CASIRAGHI, Milano (IT); Gabriele NORCINI, Comabbio (VA) (IT); Mauro TENCONI, Gazzada (VA) (IT); Giovanni FLORIDI, Novara (IT); Giuseppe LI BASSI, Gavirate (VA) (IT); Enzo MENEGUZZO, Sesto Calende (VA) (IT)

(73) Assignee: LAMBERTI SPA, Albizzate (VA) (IT)

(21) Appl. No.: 15/157,867

(22) Filed: May 18, 2016

Related U.S. Application Data
(62) Division of application No. 14/349,554, filed on Apr. 3, 2014, now abandoned.

(51) Int. Cl. C08B 37/00; C08B 30/12; C08B 15/04

(52) U.S. Cl. CPC C08B 37/0096; C08B 15/04; C08B 30/12

(57) ABSTRACT

Procedure for depolymerising polysaccharides using UV-vis light irradiation catalyzed by a radical photoinitiator. The polysaccharides obtained with the procedure of the invention have a average number molecular weight comprised between 5,000 and 500,000 and when dissolved in water give solutions with high concentrations and low viscosity.

### CROSS-REFERENCE TO RELATED APPLICATIONS

This application is a divisional application of U.S. patent application Ser. No. 14/349,554, filed Apr. 3, 2014, which claims priority from International Application No.: PCT/EP2012/069163, filed Sep. 28, 2012, the entire disclosure of which is incorporated herein by reference in its entirety.

### TECHNICAL FIELD

This invention is referred to a procedure for depolymerizing polysaccharides using UV-Vis irradiation catalyzed by a radical photoinitiator.

The polysaccharides obtained with the procedure of the invention have a number average molecular weight comprised between 5,000 and 500,000 and when dissolved in water give solutions with a high concentration and low viscosity.

### BACKGROUND ART

The behaviour of polysaccharides is strongly influenced by their molecular weight; the degree of polymerisation (DP) is an index of molecular weight and is therefore strongly related to properties such as the viscosity and the rheological behaviour of polysaccharide solutions.

Low molecular weight polysaccharides may be obtained from higher molecular weight polysaccharides by reducing the molecular weight (depolymerization). Low molecular weight polysaccharide derivatives may be obtained either by appropriately choosing the starting material for the derivatization, for example a depolymerized polysaccharide, or they may be produced from higher molecular weight polysaccharides derivatives by reducing the molecular weight during or after their synthesis.

Low molecular weight polysaccharides are employed in various industrial fields, where high filming properties and/or adhesion is required and highly concentrated solutions are needed, for example in the paper making industry, in froth flotation for mineral separation and in subterranean well operations.

Various chemical, physical and enzymatic methods useful for the depolymerisation of polysaccharides are known.

A common method for reducing the molecular weight of polysaccharides and polysaccharide derivatives requires the addition of aqueous oxidant solutions.

For example U.S. Pat. No. 6,054,511, WO 02/100902 and U.S. Pat. No. 4,547,571 disclose processes for producing high solids, low viscosity, aqueous polysaccharide compositions comprising stepwise or continuously reacting a polysaccharide or polysaccharide ether with hydrogen peroxide.

U.S. Pat. No. 5,708,162 discloses a process for the preparation of a low molecular weight polysaccharide ether comprising initially preparing a relatively high molecular weight polysaccharide ether suspension, e.g. a slurry, adding a perborate and carrying out an oxidative degradation in an alkaline medium at temperature between 25 and 90° C.

WO 01/07485 discloses a process for the depolymerization of polysaccharides or polysaccharide derivatives at increased temperatures comprising mixing at least one polysaccharide with a predetermined amount of at least one peroxo compound. Suitable polysaccharides are starch, cellulose, inulin, chitin, alginic acid, and guar gum. Suitable peroxo compounds are urea hydrogen peroxide (i.e. “Percarbamid” or carbamide peroxide), percarbonate and perborate.

In EP 708113, WO 2004/000885 and WO 02/06348 low molecular weight polysaccharides are obtained using electron beam or γ-ray irradiation.

Enzymatic depolymerisation of polysaccharides is described, for example, in WO 99/04027, GB 2281073 and EP 382577.

The enzymatic depolymerisation has been also studied in the academic literature and described in many publications, by way of example in: Yu Cao et al., Carbohydrate Research, 337 (2002), 1291-1296; Siddiqui K. S. et al., Enzyme and Microbial Technol., 27 (2000) 467-474; Kumakura M. et al., in Z. Naturforsch., 38c, (1983) 79-82.

Treatments with ultrasounds have been used to depolymerise polysaccharides (see for example WO 2010/055250).

Numerous problems and disadvantages are encountered when these methods of depolymerisation are applied: depolymerization of the polysaccharide or polysaccharide derivative usually takes several hours; any remaining oxidant must be destroyed before the polysaccharide or polysaccharide ether is recovered and this may represent a safety problem; in some processes the depolymerization takes place in suspension, typically in isopropanol or in a mixture of isopropanol and water: the use of organic solvents is not desirable and represents a waste and environmental problem. It also increases the volume of the starting material and final product and thus adds costs to the manufacturing, storage and transporting stages; discolouring (yellowing) of the depolymerised polysaccharide often occurs when chemical agents are used, together with the formation of many by-products; the inhibition of enzymatic activity when enzymes (for example cellulases or mannanases) are used may represent a problem, leading frequently to very low molecular weight polysaccharides and to polysaccharide aqueous solutions whose viscosity is unstable over the time; when polysaccharide is depolymerised in aqueous solution with an enzyme, large amounts of water shall be removed; when depolymerisation is carried on by electron beam or γ-irradiation, the complexity and the cost of the equipment may represent a disadvantage; moreover substituents can be split off from the polysaccharide derivatives in the form of dealkylation and dealkoxylation reactions during the irradiation; ultrasonic depolymerization method is not suited for industrial depolymerization of a large bulk of polysaccharide, because of its low efficiency.

For all the reasons stated above, a simple and low-cost process for the preparation of polysaccharides or polysaccharides derivatives which are stable over time, uncoloured, ready to use and have low molecular weight is still desirable in the art.

UV irradiation has been proposed for the degradation/depolymerisation of polysaccharides, such as in CN 101544704.

U.S. Pat. No. 3,352,773 describes a method to convert polysaccharides to saccharides of low molecular weight by irradiation with light in the presence of a salt of nitrous or hyponitric acid.

Burana-osot, J. et al., Carbohydrate Research 344, 2023-2027, (2009) describe a photochemical reaction for the partial depolymerization of sodium alginate using ultraviolet light in the presence of titanium dioxide.

We have now surprisingly found that it is possible to reduce efficiently and rapidly the molecular weight of polysaccharides or polysaccharides derivatives by depolymerizing using UV-Vis irradiation catalyzed by a radical photoinitiator (photodepolymerization).

The process according to the invention is much faster than those previously mentioned and allows the elimination of large quantities of water and/or solvent (with saving in operating time and energy) and it preserves the product from excessive thermal and/or chemical stress.

Apart from avoiding the aforementioned drawbacks, the present invention provides a polysaccharide having the desired low molecular weight and high content of active substance when dissolved in an aqueous medium. The process of the invention is easily controllable and can be carried out in one step, within an acceptable time period.

### DESCRIPTION OF THE INVENTION

It is therefore a fundamental object of the present invention a process for depolymerising polysaccharides, characterised by the fact that it comprises the following steps:

contacting a polysaccharide with from 0.01 to 10% by weight of a radical photoinitiator;

homogenizing to form a mixture of polysaccharide and photoinitiator;

irradiating with UV-Vis rays the homogenized mixture of polysaccharide and photoinitiator.

The present invention also provides a polysaccharide which has been photodepolymerized according to the process described above, wherein the polysaccharide has a number average molecular weight of 5,000 to 500,000 and a polydispersity index (PDI) in the range from 1 to 8.

It is another object of the present invention the use of said polysaccharide in subterranean well operations, in the paper making industry, in froth flotation for mineral separation, in cosmetics, pharmaceuticals and in other industrial applications.

### DESCRIPTION OF THE DRAWINGS

FIG. 1 is a chromatogram obtained by gel permeation chromatography of a guar depolymerized according to this invention (dotted line) and of a guar depolymerized with an oxidizing agent (full line).

### DETAILED DESCRIPTION OF THE INVENTION

In accordance with the present invention, any polysaccharide can be used.

“Polysaccharide” as used herein means a polymer comprising a plurality of monosaccharides (sugar units), typically pentose and/or hexose sugar units. Non-limiting examples of suitable polysaccharides include starches, celluloses, hemicelluloses, xylans, gums, chitin, polygalatomannans, polyarabinans, polygalactans and mixtures thereof. The term “polysaccharide” is also meant to include polymers with heteroatoms present in the polysaccharide structure, such as chitin and/or chitosan, or polymers that comprise different types of sugar units (heteropolysaccharide), for example, it may comprise pentose sugar units and hexose sugar units.

In the present text the term “polysaccharide” is meant to include also polysaccharide derivatives.

“Polysaccharide derivatives” refers to polysaccharides modified by chemical reactions resulting in chemical groups covalently bonded to the polysaccharide, e. g., methyl cellulose, ethyl cellulose, carboxymethyl cellulose, hydroxyethyl cellulose, cellulose acetate, cellulose acetate butyrate, cellulose acetate propionate, starch derivatives, hydroxypropyl guar, carboxymethyl guar, amylopectin and its derivatives and other chemically and physically modified starches, and the like.

These polysaccharides are known in the art and either are commercially available or can be manufactured using methods well known per se in the art.

Preferred polysaccharides for use in the present invention are water soluble compounds.

Suitable, non limitative examples of water soluble polysaccharides include polygalactomannans, chitosan, pectin, alginate, hyaluronic acid, agar, xanthan, dextrin, starch, amylose, amylopectin, alternan, gellan, mutan, dextran, pullulan, fructan, gum arabic, carrageenan, glycogen, glycosaminoglycans, murein and bacterial capsular polysaccharides.

Example of suitable polygalactomannans are guar gum, locust bean gum, tara gum, flame tree gum and cassia gum.

Suitable examples of water soluble polysaccharide derivatives include carboxymethyl-, hydroxypropyl-, hydroxyethyl-, ethyl-, methyl-ether polysaccharide derivatives, hydrophobically modified polysaccharide derivatives, cationic polysaccharide derivatives and mixed polysaccharide derivatives.

Examples of cellulose derivatives are hydroxyethyl cellulose, ethylhydroxyethyl cellulose, carboxymethyl cellulose, carboxymethyl hydroxyethyl cellulose, methyl cellulose, ethylcellulose, methyl hydroxypropyl cellulose, carboxymethylmethyl cellulose, hydrophobically modified carboxymethylcellulose, hydrophobically modified hydroxyethyl cellulose, hydrophobically modified hydroxypropyl cellulose, hydrophobically modified methyl cellulose, nitrocellulose, cellulose acetate, cellulose sulfate and cellulose phosphate.

Examples of guar derivatives include carboxymethyl guar, hydroxyethyl guar, hydroxypropyl guar, carboxymethyl hydroxypropyl guar hydrophobically modified hydroxypropyl guar, hydrophobically modified carboxymethyl guar, cationic hydroxypropyl guar and hydrophobically modified cationic guar.

Other galactomannan derivatives of interest are, for example, the hydroxethylated and carboxymethylated derivatives of Cassia Gum.

Examples of starch derivatives include carboxymethyl starch and hydroxypropyl starch.

Other polysaccharides may be similarly derivatized.

According to an embodiment of the invention, the derivatized polysaccharides have a degree of substitution in the range of 0.01-3.0 or a molar substitution comprised between 0.01 and 4.0.

The expression “degree of substitution” (DS) refers to the average number of sites that are substituted with a functional group (e. g., carboxymethyl) per anhydroglycosidic unit in the polysaccharide. Usually each of the anhydroglycosidic units of a polysaccharide contains on the average three available hydroxyl sites. A degree of substitution of three would mean that all of the available hydroxyl sites have been substituted with functional groups.

With the expression “molar substitution” (MS), we mean the number of substituents (e.g. hydroxypropyl) on each anhydroglycosidic unit of the polysaccharide.

More preferably, the polysaccharide is a water soluble polysaccharide or a water soluble polysaccharide derivative selected from the group consisting of guar, guar derivatives and cellulose derivative, even more preferably, the polysaccharide is guar, hydroxypropyl guar or carboxymethyl cellulose.

The average molecular weight (MW) of the polysaccharide to be used in accordance with the present invention can vary over a wide range, typically from 250,000 to 3,000,000 Dalton, and can be measured, for example, by using gel permeation chromatography (GPC).

The polysaccharide of steps from a) to c) is preferably in solid form.

The expression “in solid form” is meant to include powders, splits, granules, flakes, particles, and the like, both in the dry form and also in a heterogeneous phase system, such as after swelling or dispersing in the presence of an organic solvent and/or of water.

Actually, it can be advantageous to incorporate a small amount of water and/or an organic solvent in step a), b) or c), since the incorporation of water or organic solvent may improve the compatibility of the photoinitiator with the polysaccharide moiety.

The organic solvent may be chosen in the group consisting of water soluble solvents, such as lower alcohols, acetone etc.

The organic solvent can be in any amount in the range from 1 to 50 wt %, and more preferably from 1 to 25 wt %, based on the total weight of the mass of the ingredients of the steps a), b) and c).

It is most preferred to add only water without any other solvent, as water does not give environmental problems.

It is preferable in particular that the overall water and organic solvent content of the mixture does not exceed 80% of the weight of total mass of the ingredients of steps from a) to c).

In step a) the radical photoinitiator may be added to the polysaccharide in liquid form, for example as a solution, emulsion or suspension, or the polysaccharide may be added to the liquid form of the radical photoinitiator.

A radical photoinitiator is a chemical compound that initiates the polymerization of monomers when exposed to UV-Vis radiation by the formation of free radicals. Photoinitiators are frequently used in UV-curable compositions, such as UV curable inkjet inks. In the present text the generic term “photoinitiator” is used to indicate radical photoinitiator.

Two types of radical photoinitiators can be used in the process of the invention: Norrish Type I and Norrish Type II photoinitiators.

A Norrish Type I photoinitiator is an initiator which cleaves after excitation, yielding the initiating radical immediately. A Norrish type II-initiator is a photoinitiator which is activated by UV-Vis radiation and forms free radicals by hydrogen abstraction from a second compound that becomes the actual initiating free radical.

Norrish type II photo-initiators always require a co-initiator; aliphatic amines or aromatic amines and thiols are preferred examples of co-initiators. After transfer of a hydrogen atom to the Norrish type II initiator, the radical generated on the co-initiator initiates the polymerization.

The photoinitiator may be a monofunctional compound or a multifunctional compound having more than one photoinitiating group.

Suitable Norrish Type I photoinitiators that can be used are benzoin derivatives, methylolbenzoin and 4-benzoyl-1,3-dioxolane derivatives, α-dialkoxyacetophenones, α-hydroxyketones, α-aminoketones, benzil ketals, acylphosphine oxides, bisacylphosphine oxides, acylphosphine sulphides, halogenated acetophenone derivatives, ketosulfones, triazines and combinations of these photoinitiators; examples of suitable Norrish Type I photoinitiators are: 2-hydroxy-4′-(2-hydroxyethoxy)-2-methyl propiophenone, benzildimethyl ketal or 2,2-dimethoxy-1,2-diphenylethanone, 1-hydroxy-cyclohexyl-phenyl ketone, 2-hydroxy-2-methyl-1-phenylpropan-1-one, 2-methyl-1-[4-(methylthio)phenyl]-2-morpholino propan-1-one, 2-benzyl-2-dimethylamino-1-(4-morpholino phenyl)-butan-1-one, poly{2-hydroxy-2-methyl-1-[4-(1-methylvinyl) phenyl]propan-1-one}, blend of poly {2-hydroxy-2-methyl-1-[4-(1-methylvinyl)phenyl]propan-1-one} and 2-hydroxy-2-methyl-1-phenyl-propan-1-one, blend of poly {2-hydroxy-2-methyl-1-[4-(1-methylvinyl)phenyl]propan-1-one}, 2,4,6-trimethylbenzoyl diphenyl-phosphine oxide, 1-[4-[(4-benzoyl-phenyl)-thiol-phenyl]-2-methyl-2-[(4-methyl-phenyl)-sulfonyl]-propan-1-one, acylphosphine oxides such as 2,4,6-trimethylbenzoyl diphenyl phosphine oxide, bis(2,4,6-trimethylbenzoyl)-phenyl-phosphine-oxide, blend of bis (2,6-dimethoxybenzoyl)2,4,4-trimethyl-pentyl phosphine oxide and 2-hydroxy-2-methyl-1-phenyl-propan-1-one, and the like.

Examples of Norrish Type II photoinitiators that can be used include aromatic ketones such as benzophenone, xanthone, derivatives of benzophenone (e.g. chlorobenzophenone), blends of benzophenone and benzophenone derivatives (e.g. a 50/50 blend of 4-methyl-benzophenone and benzophenone), Michler's Ketone, Ethyl Michler's Ketone, thioxanthone and thioxanthone derivatives like isopropyl thioxanthone, anthraquinones (e.g. 2-ethyl anthraquinone), coumarin, or chemical derivatives or combinations of these photoinitiators. Suitable co-initiators include, but are not limited to, aliphatic, cycloaliphatic, aromatic, aryl-aliphatic, heterocyclic, oligomeric or polymeric amines.

Also mixtures of both Norrish types of radical photoinitiators can be used.

The preferred photoinitiators are water-soluble photoinitiators or water-dispersible or can be modified to become water-soluble or water-dispersible.

The most preferred photoinitiators belong to the class of water soluble α,α-hydroxyketones, such as 4-carboxy-2-hydroxy-2-methyl-1-phenylpropan-1-one or a salt thereof and 1-[4-(2-(N,N-diethanolamine)ethoxy)phenyl]-2-hydroxy-2-methyl propan-1-one or a salt thereof.

The depolymerization of the polysaccharides of the invention occurs on exposure of the mixture of the polysaccharide and the photoinitiator to any source of radiation emitting UV-Vis radiation at a wavelength within the ultraviolet and visible spectral regions.

The wavelength or wavelength range to be employed may vary depending on the nature of the radical photoinitiator but, preferably, lies within the range from about 260 to 400 nm. Suitable sources of radiation include mercury, xenon, carbon arc and tungsten filament lamps, led, sunlight. More specifically, rays from a high-pressure mercury lamp (450 W), for instance, can be used for the irradiation, with rays shorter in wavelength than 260-270 nm being cut off.

Irradiation may last from about some second to hours, depending upon the amounts of polysaccharide, the photoinitiator being utilized and its concentration, the radiation source, the distance of the mixture from the source and the thickness of the material to be treated.

The irradiation can be applied directly to a homogenized mixture of polysaccharide mass in solid form and radical photoinitiator, but even to a homogenized mixture of the radical photoinitiator and the polysaccharide dissolved in the liquid medium.

The process can be performed either in batch or in continuous mode.

According to a preferred embodiment of this invention, the mixture in the form of paste to be irradiated is placed in a tray with a thickness of at least some millimeters to facilitate irradiation of the material by the UV-Vis rays. The tray is then placed on a conveyor belt and transferred into a radiation chamber. The layer of material being depolymerized should have a substantially uniform thickness in order to obtain good polydispersity values for the depolymerized product. Advantageously the apparatus is equipped with system for mixing the paste for a more homogeneous depolymerization.

In some embodiments of the present invention, a pH-adjusting agent may be added to the mixture. In depolymerization reactions of a polysaccharide, an alkaline environment can be preferred as it may help, inter alia, to swell the polysaccharide particles. The addition of a pH-adjusting agent can also help the dissolution of the photoinitiator in the liquid medium. It is within the ability of one skilled in the art to determine whether and how much of a pH-adjusting agent may be helpful. Once the depolymerization reaction is complete, the pH of the product may be adjusted through the addition of a pH-adjusting agent. The pH should be adjusted to a range of about 4 to about 10 (in certain preferred embodiments, from about 6 to about 8.5).

The temperature gives no significant influence upon the result of the present depolymerization method. Therefore, the depolymerization is usually performed at a temperature lower than 100° C., preferably at ambient temperature.

The number average molecular weight of the depolymerized polysaccharide obtained using the process of the invention typically is in the range of 5,000 to 500,000 Dalton.

The polysaccharide according to the present invention has a polydispersity index (PDI) in the range of 1-8. According to a preferred embodiment, the PDI of the polysaccharide is in the range from 2 to 6.

The polysaccharide can be derivatized prior to or after the depolymerization step. In a preferred embodiment, the polysaccharide is derivatized before the depolymerization step.

At the end of the process the depolymerized polysaccharide can be used as such or it can be dried and recovered using means known in the art. Examples of such means include air drying, filtering, centrifuging, addition of solvents, freeze or spray drying and the like. The use of fluidized bed drying is particularly recommended.

Optionally, before the drying step, the polysaccharide of the invention can be purified by washing with water, an organic solvent, or a mixture of both, optionally in the presence of a crosslinker.

The polysaccharides of the invention are useful in subterranean well operations including fracturing, and frac-packing, in the paper making industry, in the textile industry, in building operations, in froth flotation for mineral separation, in biomass depolymerization, in cosmetics, pharmaceuticals and other industrial applications, such as flowable pesticides, cleaners, ceramics and coatings.

The following examples of the invention are given by way of illustration and are not intended to limit the invention.

### EXAMPLES

### Test Methods

The viscosity of the solutions was measured 2 hours after the dissolution of the polysaccharide or after the irradiation with a DV-E Brookfield® viscometer at 20° C. and at 20 rpm. The polysaccharide concentration in the solutions for the viscosity determinations, unless differently indicated, must be considered 1% by weight.

The moisture content of the samples was determined with a IR moisture analyzer Mettler PM 460/LP.

Gel permeation chromatography (GPC) was used to determine the weight average molecular weight (Mw), the number average molecular weight (Mn), molecular weight distribution (MWD) and the polydispersity index (PDI), by using the following method.

The depolymerized guar samples were prepared by dissolving at a concentration of 0.3% w/vol of sample in 0.10 M ammonium acetate (“mobile phase solution”).

Sodium polyacrylates with different molecular weights were used as molecular weight standards.

Two hundred microliters of each solution, filtered on a 0.45 micron membrane filter were injected into a HPLC equipped with a evaporative light scattering detector detector.

The following columns were used at a temperature of 60° C.: Supelco Progel—TSK G3000 PWXL, G6000 PWXL, and Progel-TSK PWXL guard column. The HPLC was set at a flow rate of 0.8 ml/min for 50 minutes.

### Photoinitiators

The photoiniators used in the Examples of the present invention are shown in Table 1.

### Photodepolymerization in Solution.

### Examples 1-4

### Photodepolymerization of Guar Gum

15 g of guar gum flour were dissolved in 1485 g of deionized water; after 30 minutes of vigorous mechanical stirring the solution were divided in 4 lots of 350 g each.

TABLE 1

| Photoinitiator | Chemical Name | Chemical Structure |
|---|---|---|
| Benzophenone | diphenylmethanone | 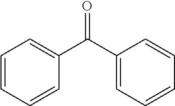 [SMILES: O=C(c1ccccc1)c1ccccc1] |
| Esacure KL200 | 2-hydroxy-2-methyl-1- phenylpropan-1-one | 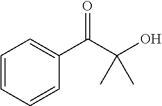 |
| Esacure | aqueous emulsion of | |
| DP250* | different photoinitiators | |
| LFC1958 | 4-carboxy-2-hydroxy-2-methl-1- phenylpropan1-one | 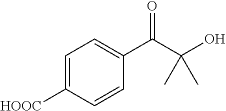 |
| LFC2179 | 1-[4-(2-(N,N- diethanolamine)ethoxy)phenyl]-2- hydroxy-2-methyl propan-1-one | 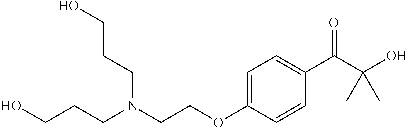 [SMILES: CC(C)(O)C(=O)c1ccc(OCCN(CCCO)CCCO)cc1] |
| LFC1970 | 2-(N-(2-(2-hydroxyethoxy)ethyl)- N-methylamino)-2-methyl-1-(4- (phenylthio)phenyl)propan-1-one | 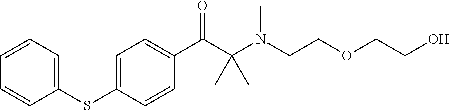 [SMILES: CN(CCOCCO)C(C)(C)C(=O)c1ccc(Sc2ccccc2)cc1] |
| LFC2634 | 1-(4-(2,3- dihydroxypropoxy)phenyl)-2- hydroxy-2-methyl propan-1-one | 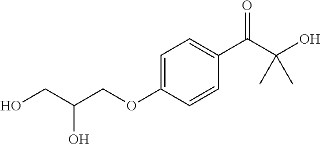 [SMILES: CC(C)(O)C(=O)c1ccc(OCC(O)CO)cc1] |
| 4-hydroxy- benzophenone | (4-hydroxyphenyl) (phenyl)methanone | 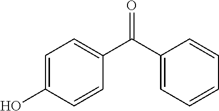 [SMILES: O=C(c1ccccc1)c1ccc(O)cc1] |
| Irgacure 369** | 2-benzyl-2-(dimethylamino)-1-[4- morpholinyl) phenyl]-1-butanone hydrochloride | 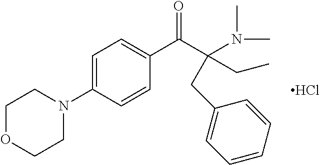 [SMILES: CCC(Cc1ccccc1)(C(=O)c1ccc(N2CCOCC2)cc1)N(C)C ; Cl] |
| Irgacure 2959** | 1-(4-(2-hydroxyethoxy)phenyl)-2- hydroxy-2-methylpropan-1-one | 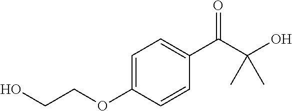 [SMILES: CC(C)(O)C(=O)c1ccc(OCCO)cc1] |

*Commercialized by Lamberti S.p.A.
**Commercialized by Basf

0,105 g of different photoinitiators (PI), Examples from 2 to 4, were added to the guar gum solutions which were stirred for 15 minutes after the addition in order to obtain a good dispersions of the photoinitiators. Example 1 is the guar gum solution without any addition of photoinitiators.

All the samples were irradiated under stirring with a mercury high-pressure immersion UV lamp (125 W). The viscosity of the solutions over the time are resumed in Table 2.

TABLE 2

| | | Irradiation | |
|---|---|---|---|
| | | time | Viscosity |
| Sample | Photoinitiator | (min) | (mPa*s) |
| Example 1* | None | 0 | 4910 |
| | | 10 | 4520 |
| | | 30 | 3950 |
| Example 2 | Benzophenone | 0 | 4800 |
| | | 10 | 42.5 |
| | | 20 | 17.5 |
| Example 3 | Esacure KL200 | 0 | 4880 |
| | | 10 | 50 |
| | | 20 | 44.5 |
| Example 4 | Esacure DP250 | 0 | 4880 |
| | | 10 | 2000 |
| | | 20 | 600 |

*Comparative

### Examples 5-8

### Photodepolymerization of Guar Gum Under Nitrogen or Air

Two solutions of guar gum were prepared dissolving 10 g of guar gum flour in 990 g of deionized water in a 1.5 L reactor under nitrogen atmosphere. After 30 minutes of stirring with a mechanical rod stirrer 0.290 g of KL-200 or benzophenone were added to the solutions which were then stirred under nitrogen for other 15 minutes.

The solutions of Examples 5 and 7 were irradiated under stirring and nitrogen atmosphere with a mercury high-pressure immersion UV lamp (125 W) for 10 minutes.

Examples 6 and 8 were prepared with the same procedure but using air as the reaction atmosphere.

The viscosity of the solutions before and after UV irradiation are resumed in Table 3.

TABLE 3

| | | | Irradiation | Viscosity |
|---|---|---|---|---|
| Sample | Photoinitiator | Atmosphere | (min) | (mPa*s) |
| Example 5 | KL200 | N₂ | 0 | 4540 |
| | | | 10 | 150 |
| Example 6 | KL200 | Air | 0 | 4450 |
| | | | 10 | 130 |
| Example 7 | Benzofenone | N₂ | 0 | 5250 |
| | | | 10 | 940 |
| Example 8 | Benzofenone | Air | 0 | 4360 |
| | | | 10 | 360 |

### Examples 9-18

### Photodepolymerization of Guar Gum with Water Soluble Photoinitiators

Ten solutions were prepared by dissolving 3.5 g of guar gum flour in 346.5 g of deionized water and stirring for 30 minutes.

Equi-molar quantities (0.64 mmol) of the following photoinitiators were added to each solution:
Example 9: no photoinitiator (comparative);
Example 10: 0.105 g of K1-200;
Example 11: 0.143 g of I-2959;
Example 12: 0.199 g of LFC-2179;
Example 13: 0.133 g of LFC-1958;
Example 14: 0.199 g of LFC-2179 and 0.154 g of HCl 15%;
Example 15: 0.133 g of LFC-1958 and 0.085 g of NaOH 30%;
Example 16: 0.234 g of 1-369;
Example 17: 0.234 g of 1-369 and 0.64 g of HCl 1.0 M;
Example 18: 0.239 g of LFC-1970.

After the addition of the photoinitiator the solutions were stirred for 15 minutes and irradiated for 30 minutes with a mercury high-pressure immersion UV lamp (125 W). The viscosity before and after UV irradiation are reported in Table 4.

TABLE 4

| | | Initial | Final |
|---|---|---|---|
| | | Viscosity | Viscosity |
| Sample | Photoinitiator | (mPa*s) | (mPa*s) |
| Example* 9 | None | 3610 | 3650 |
| Example 10 | KL-200 | 3450 | 67 |
| Example 11 | I-2959 | 3950 | 560 |
| Example 12 | LFC-2179 | 3520 | 2080 |
| Example 13 | LFC-1958 | 4050 | 2155 |
| Example 14 | LFC-2179 + HCl | 3450 | 140 |
| Example 15 | LFC-1958 + NaOH | 3510 | 274 |
| Example 16 | I-369 | 2986 | 2200 |
| Example 17 | I-369 + HCl | 2850 | 2420 |
| Example 18 | LFC-1970 | 3570 | 2700 |

* Comparativo

### Examples 19-21

### Photodepolymerization of Carboxymethyl Cellulose

12 g of carboxymethyl cellulose (CARBOCEL MA500 commercialized by Lamberti S.p.A.) were dissolved in 1090 g of deionized water and stirred for 30 minutes with a mechanical rod stirrer.

The solution was divided in three lots 350 g each and equivalent molar quantities of the following photoinitiators were added to each solution:
Example 19: no photoinitiators (comparative);
Example 20: 0.105 g of KL-200;
Example 21: 0.133 g of LFC1958+0.085 g of NaOH 30%.

After the addition of the photoinitiators the solutions were stirred for 15 minutes and irradiated for 30 minutes with a mercury high-pressure immersion UV lamp (125 W). The viscosity before and after UV irradiation are resumed in Table 5.

TABLE 5

| | | Initial | Final |
|---|---|---|---|
| | | Viscosity | Viscosity |
| Sample | Photoinitiator | (mPa*s) | (mPa*s) |
| Example 19* | None | 4180 | 4120 |
| Example 20 | KL200 | 4460 | 60 |
| Example 21 | LFC-1958 + NaOH | 3810 | 140 |

*Comparative

### Examples 22-24

### Photodepolymerization of Carboxymethyl Starch

48 g of carboxymethyl starch (EMPRINT CE, commercialized by Emsland) were dissolved in 1052 g of deionized water and stirred for 30 minutes with a mechanical rod stirrer.

The solution were divided in three lots of 350 g each and equivalent molar quantities of photoinitiators were added to each lot:
Example 22: no photoinitiator (comparative);
Example 23: 0.46 g of KL-200;
Example 24: 0.58 g of LFC1958+0.37 g of NaOH 30%.

After the addition of the photoinitiators the solutions were stirred for 15 minutes and irradiated for 30 minutes with a mercury high-pressure immersion UV lamp (125 W). The viscosity before and after UV irradiation are reported in Table 6.

TABLE 6

| | | Initial | Final |
|---|---|---|---|
| | | Viscosity | Viscosity |
| Sample | Photoinitiator | (mPa*s) | (mPa*s) |
| Example 22* | None | 8460 | 7590 |
| Example 23 | KL200 | 7990 | 3770 |
| Example 24 | LFC-1958 + NaOH | 7760 | 4000 |

*Comparative

Photodepolymerization in Suspension.

### Examples 25-28

### Photodepolymerization of a Crosslinked Guar Gum

Four suspensions were prepared by adding 3.5 g of a cross-linked guar gum (INDALCA XD15, commercialized by Lambent S.p.A.) in 346.5 g of deionized water and 5.0 mL of NaOH 30% solution.

Equivalent molar quantities of photoinitiators were added to each suspension:
Example 25: no photoinitiator (comparative);
Example 26: 0.105 g of KL-200;
Example 27: 0.133 g of LFC-1958 and 0.085 g of NaOH 30% solution;
Example 28: 0.13 g of 4-hydroxybenzophenone and 0.085 g of NaOH 30% solution.

After the addition of the photoinitiators, the four suspensions were stirred for 15 minutes and then irradiated for 30 minutes with a mercury high-pressure immersion UV lamp (125 W).

After the irradiation the pH suspensions was brought to a value of about 5 with 80% acetic acid to avoid the degradation of the polysaccharide. The resulting solution stirred for 30 minutes with a mechanical rod stirrer.

The viscosity of the solutions after UV irradiation are reported in Table 7.

TABLE 7

| | | Viscosity |
|---|---|---|
| Sample | Photoinitiator | (mPa*s) |
| Example 25* | None | 4000 |
| Example 26 | KL-200 | 1100 |
| Example 27 | LFC-1958 + NaOH | 1650 |
| Example 28 | 4-hydroxybenzophenone + | 2800 |
| | NaOH | |

*Comparative

Photodepolymerization in Paste.

For photodepolimerizing in paste 10 g of each samples were uniformly distributed on a flat sample holder (area 170 cm²) and were irradiated for different period of time, as reported in the Tables below, by means of a 240 W/cm microwave UV lamp. Each sample was removed from the irradiation area every 7 seconds, stirred, redistributed on the sample holder and reintroduced in the irradiation area.

### Examples 29-34

### Effect of Moisture Content and Irradiation Time

For the preparation of the blanks 55.56 g of guar gum flour were sprayed with 44.44 g of deionized water and homogenized for 10 minutes in a mixer (Examples 29 and 30).

40 g of guar gum flour were sprayed with a dispersion of 1.08 g of KL-200 in 20 g of deionized water and homogenized for 10 minutes in a mixer. The paste was divided in 3 samples, Examples from 31 to 33, and each sample was irradiated for different period of time.

55.56 g of guar gum flour were sprayed with a dispersion of 1.50 g of KL-200 in 44.44 g of deionized water and homogenized for 10 minutes in a mixer (Example 34).

The total irradiation time and the viscosity of the guar gum after the treatment are showed in Table 8.

TABLE 8

| | | Irradiation | | |
|---|---|---|---|---|
| | KL-200 | Time | Moisture | Viscosity |
| Sample | (%) | (sec) | (%) | (mPa*s) |
| Example 29* | None | 0 | 49.8 | 3720 |
| Example 30* | None | 14 | 49.8 | 2080 |
| Example 31 | 2.7 | 7 | 41.5 | 1300 |
| Example 32 | 2.7 | 14 | 41.5 | 204 |
| Example 33 | 2.7 | 28 | 41.5 | 36 |
| Example 34 | 2.7 | 14 | 50.2 | 430 |

*Comparative

### Examples 35-37

### Effect of the Photoinitiator Content

Three samples of 40 g of guar gum flour were sprayed with the following suspension:
Example 35: 20 g of deionized water+0.18 g of KL-200;
Example 36: 20 g of deionized water+0.36 g of KL-200;
Example 37: 20 g of deionized water+1.08 g of KL-200:

The mixtures were homogenized for 10 minutes in a mixer. The total irradiation time and the viscosity of 1% polysaccharide solutions after the treatment are showed in Table 9.

TABLE 9

| | | Irradiation | | |
|---|---|---|---|---|
| | KL-200 | Time | Moisture | Viscosity |
| Sample | (%) | (sec) | (%) | (mPa*s) |
| Example 35 | 0.45 | 14 | 39.8 | 540 |
| Example 36 | 0.90 | 14 | 39.2 | 516 |
| Example 37 | 2.7 | 14 | 40.6 | 204 |

### Examples 38-41

### Photodepolymerization of Cellulose

Equi-molar quantities of photoinitiators dissolved or dispersed in 25 g of deionized water were added to 10 g of grounded wood cellulose:
Example 39: no photoinitiators (comparative);
Example 40: 0.3 g of KL-200;
Example 41: 0.38 g of LFC1958+0.2 g of NaOH 30%.

After the addition of the fotoinitiator solution/dispersion the sample were left at 5° C. overnight in order to fully hydrate the cellulose fibers. The degree of polymerization (DP) of the three samples after irradiation was determined according to the method ISO-5351 (2004) and the results are reported in Table 10 in comparison with the starting cellulose (Example 38).

### Examples 42-45

### Effect of Solid Photoinitiator Pre-Dissolved in Organic Solvent

40 g of guar gum flour powder were hydrated with 20 g of deionized water in a mixer (Example 42 and 43).

5.5 g of a benzophenone solution in isopropanol (20% by weight) was sprayed on 40 g of guar gum flour. The mixture was homogenized in a mortar and then hydrated with 20 g of deionized water in a mixer (Example 44).

1.1 g of benzophenone were added to 40 g of guar gum flour. The mixture was homogenized in a mortar and then hydrated with 20 g of deionized water in a mixer (Example 45).

The viscosity of the polysaccharides of Examples 44 and 45 were compared (see Table 11) with the not irradiated guar gum flour (Example 42).

TABLE 10

| | | | Irradiation | |
|---|---|---|---|---|
| | | Moisture | Time | |
| Sample | Photoinitiator | (%) | (sec) | DP |
| Example 38* | None | 7.00 | 0 | 2565 |
| Example 39* | None | 72.50 | 28 | 1395 |
| Example 40 | KL-200 | 71.22 | 28 | 915 |
| Example 41 | LFC-1958 + NaOH | 70.58 | 28 | 1099 |

*Comparative

TABLE 11

| | | Irradiation | | |
|---|---|---|---|---|
| | Benzophenone | Time | Moisture | Viscosity |
| Sample | (%) | (sec) | (%) | (mPa*s) |
| Example 42* | 0 | 0 | 49.8 | 4070 |
| Example 43* | 0 | 14 | 49.8 | 2080 |
| Example 44 | 2.75 | 14 | 41.4 | 740 |
| Example 45 | 2.75 | 14 | 39.7 | 592 |

*Comparative

### Examples 46-51

### Photodepolymerization of Guar Gum Splits

Four samples of 50 g each of triple purified guar gum splits (98%) were hydrated at 95° C. in a closed beaker with the following solution/suspension:
Example 46 and 47: 62.5 g of deionized water;
Example 48 and 49: 62.5 g of deionized water+1.9 g of LFC-1958+1.22 g of 30% NaOH;
Example 50: 62.5 g of deionized water+1.5 g of KL-200;
Example 51: 62.5 g of deionized water+2.84 g of LFC-2179+9.1 g of HCl 1.0 M.

After 45 minutes the hydrated splits were milled and exposed to UV light. The properties of the resulting guar gum are resumed in Table 12.

GPC Test

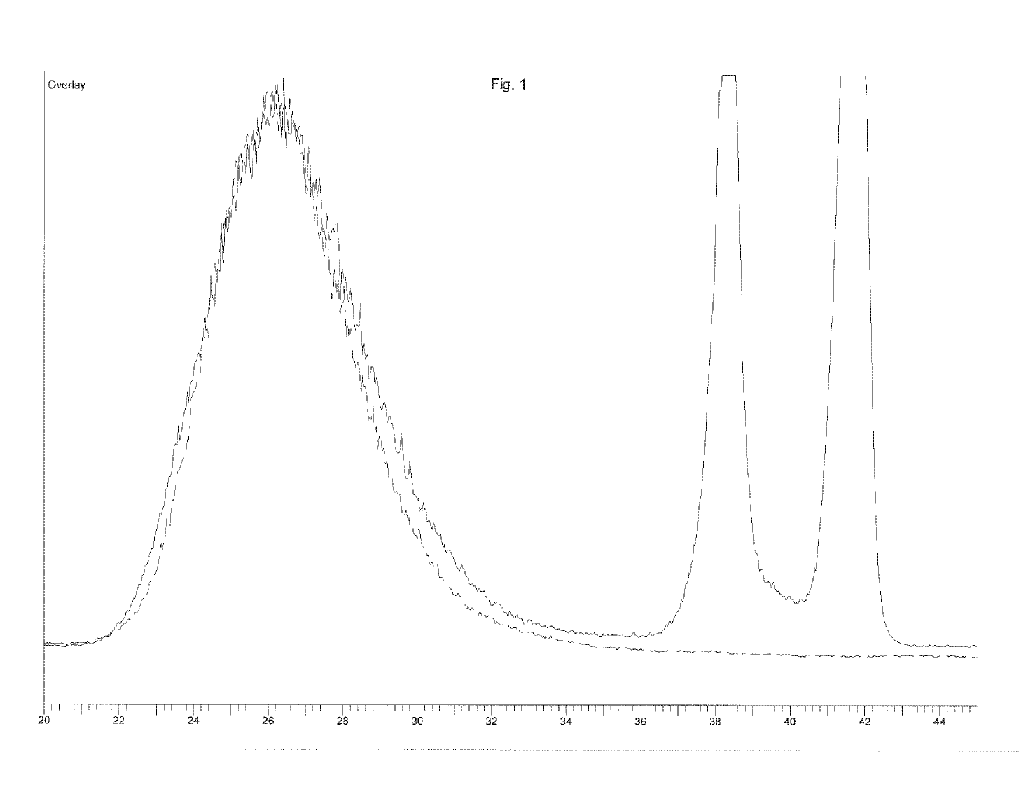

FIG. 1 is a gel permeation chromatogram of the photodepolymerized guar flour described in Example 10 and of a guar flour depolymerized with NaOH and hydrogen peroxide. The GPC results show that the photodepolymerized guar has a monomodal distribution and a weight average molecular weight of 675,783, a number average molecular weight of 249,475 and a polydispersity index of 2.71.

TABLE 12

| | | | Irradiation | Viscosity |
|---|---|---|---|---|
| | | Moisture | Time | 4% sol. |
| Sample | Photoinitiator | (%) | (sec) | (mPa*s) |
| Example 46* | None | 54.6 | 0 | >100000 |
| Example 46* | None | 53.9 | 42 | >100000 |
| Example 48 | LFC-1958 + NaOH | 53.9 | 84 | 6180** |
| Example 49 | LFC-1958 + NaOH | 53.9 | 42 | 7520 |
| Example 50 | KL-200 | 52.8 | 42 | 10260 |
| Example 51 | LFC2179 + HCl | 52.5 | 42 | 13380 |

*Comparative
**5% solution

Applicative Test

60 g of photodepolymerized guar flour of Example 10 were dissolved in 863 g of deionized water (guar content 6.5% weight). The viscosity of the obtained solution was 7,500 mPa·s.

80 g of a guar flour depolymerised with NaOH and hydrogen peroxide were dissolved in 920 of deionized water (guar content 6.5%). The viscosity of the obtained solution was 7,700 mPa·s.

Determination of Water Insoluble Residue (WIR)

500 g of sample solutions were diluted with 500 ml of deionized water and stirred for 3 minutes.

The obtained solutions were filtered under vacuum (760 mm Hg) on a 54 microns nylon canvas placed in buckner filter (diameter 11 cm).

After the filtration the filters were washed with 1000 ml of deionized water and dryed on filter paper in order to remove the excess water.

The residue on the filters was transfered in a graduated test tube and centrifuged at 4000 rpm for 2 minutes.

The amount of insoluble residue was calculated as follows:

$$\% WIR ( \frac{ml}{100 g} ) = \frac{A \times 10000}{P \times C}$$

where:

A=Volume (ml) of insoluble water residue;

P=Weight (g) of the starting solution;

C=Concentration of the filtered solution.

The results for the guar of the invention and guar of the known art are reported in Table 13.

Determination of Printability

100 g of sample solutions were placed on a printing screen (90 HD) and printed on a pipeline/cotton tissue using a printing machine (Johannes Zimmer Mini MDF 590) and a steel rod (diameter 4 mm) with a pressure of 1 bar and at a speed of 10 m/min. The printability was calculated as follows:

$$Printability ( \frac{g}{{m}^{2}} ) = \frac{B - A}{S}$$

where:

A=Weight (g) of the dried tissue before printing

B=Weight (g) of the dried tissue after printing

S=Surface (m²) of the printed tissue.

The results for the guar of the invention and guar of the known art are reported in Table 13.

TABLE 13

| Test | Invention | Comparative |
|---|---|---|
| WIR | 0.0% | 0.0% |
| Printability | 41.0 g/m² | 30.0 g/m² |

What is claimed is:

1. A process for depolymerizing a polysaccharide comprising:
contacting the polysaccharide with from about 0.01 to about 10% by weight of a radical photoinitiator;
homogenizing the polysaccharide and radical photoinitiator to form a homogenized mixture of the polysaccharide and the radical photoinitiator; and
irradiating the homogenized mixture of the polysaccharide and the radical photoinitiator with UV-Vis rays to produce a depolymerized polysaccharide.

2. The process of claim 1 wherein the depolymerized polysaccharide is a water soluble polysaccharide or a water soluble polysaccharide derivative.

3. The process of claim 1 wherein the depolymerized polysaccharide has a number average molecular weight of from about 5,000 to about 500,000.

4. The process of claim 1 wherein the depolymerized polysaccharide has a polydispersity index of from about 1 to about 8.

5. The process of claim 1 wherein the polysaccharide is selected from the group consisting of cellulose, hemicelluloses, polygalactomannans, chitin, chitosan, pectin, alginate, hyaluronic acid, agar, xanthan, dextrin, starch, amylose, amylopectin, alternan, gellan, mutan, dextran, pullulan, fructan, gum arabic, carrageenan, glycogen, glycosaminoglycans, murein and bacterial capsular polysaccharides, and derivatives thereof.

6. The process of claim 1 wherein the polysaccharide is selected from the group consisting of guar, hydroxypropyl guar and carboxymethyl cellulose.

7. The process of claim 1 wherein the radical photoinitiator is selected from the group consisting of benzoin derivatives, methylolbenzoin and 4-benzoyl-1,3-dioxolane derivatives, α,α-dialkoxyacetophenones, α-hydroxyketones, α-aminoketones, benzil ketals, acylphosphine oxides, bisacylphosphine oxides, acylphosphine sulphides, halogenated acetophenone derivatives, ketosulfones, triazines, aromatic ketones and combinations of these photoinitiators.

8. The process of claim 7 wherein the radical photoinitiator is selected from photoinitiators which are water-soluble or water-dispersible or can be adjusted to become water-soluble or water-dispersible.

9. The process of claim 8 wherein the radical photoinitiator is 4-carboxy-2-hydroxy-2-methl-1-phenylpropan-1-one or a salt thereof or 1-[4-(2-(N,N-diethanolamine)ethoxy)phenyl]-2-hydroxy-2-methyl propan-1-one or a salt thereof.

10. The process of claim 1 wherein the irradiation is applied to the homogenized mixture of polysaccharide and radical photoinitiator, and the polysaccharide is in a form selected from the group consisting of a solid, an aqueous solution, suspended in a liquid medium, and a paste.
